(19) United States
(12) Patent Application Publication
(10) Pub. No.: US 2013/0265137 A1
(43) Pub. Date: Oct. 10, 2013

(54) INTEGRATABLE FINGERPRINT SENSOR PACKAGINGS

(71) Applicant: Validity Sensors, Inc., San Jose, CA (US)

(72) Inventors: Richard Brian NELSON, Chandler, AZ (US); Paul WICKBOLDT, Walnut Creek, CA (US); Sudhakaran RAM, San Jose, CA (US)

(21) Appl. No.: 13/855,562

(22) Filed: Apr. 2, 2013

Related U.S. Application Data
(60) Provisional application No. 61/619,254, filed on Apr. 2, 2012.

(51) Int. Cl. G06K 9/00

(52) U.S. Cl. CPC G06K 9/0002
USPC 340/5.82; 324/663

(57) ABSTRACT

A method and system is disclosed which may comprise a biometric object sensor that may comprise at least one conductive layer formed from a transparent or translucent material and formed in at least one of on, in or under an outer layer of a user device housing; at least one of a transmitter trace and at least one of a receiver trace formed from the at least one of the transparent or translucent material in the conductive layer. The transparent or translucent material may form at least a portion of a touch screen display on a user device. The at least one of a transmitter trace and at least one of a receiver trace may comprise one of a plurality of transmitter traces and a receiver trace and a plurality of receiver traces and a transmitter trace or a plurality of transmitter traces and a plurality of receiver traces.

### RELATED CASES

The present Application claims priority to U.S. Provisional Patent Application Ser. No. 61/619,254, entitled INTEGRATABLE FINGERPRINT SENSOR PACKAGINGS, filed on April 2, 2012, the disclosure of which, including the Specification, Claims and Drawings is incorporated in the present application by reference for all purposes as if the same was repeated in the present application in whole.

### BACKGROUND OF THE INVENTION

Since its inception, fingerprint sensing technology has revolutionized biometric identification and authentication processes. In most cases, a single fingerprint can be used to uniquely identify an individual in a manner that cannot be easily replicated or imitated. The ability to capture and store fingerprint image data in a digital file of minimal size has yielded immense benefits in fields such as law enforcement, forensics, and information security.

However, the widespread adoption of fingerprint sensing technology in a broad range of applications has faced a number of obstacles. Among these obstacles is the need for a separate and distinct apparatus for capturing a fingerprint image. Additionally, such components are often impractical for use in systems that are designed to be of minimal size or weight. As handheld devices begin to take on a greater range of functionality and more widespread use, engineers and designers of such devices are constantly seeking ways to maximize sophistication and ease of use while minimizing size and cost. Typically, such devices only incorporate input/output components that are deemed to be essential to core functionality, e.g., a screen, a keyboard and a limited set of additional buttons.

For these reasons, fingerprint-based authentication techniques have not replaced username and password authentication in the most common information security applications such as email, online banking, and social networking. Paradoxically, the growing amount of sensitive information Internet users are entrusting to remote computer systems has intensified the need for authentication procedures more reliable than password-based techniques.

A component that is integratable into an electronic device would enhance the ability to incorporate finger print sensing technology. As will be seen, the present disclosure provides such a system that overcomes or at least diminishes these obstacles.

### SUMMARY OF THE INVENTION

An aspect of the disclosure is directed to a housing comprising: a sensor positionable within 250 microns of an uppermost surface of the housing; and a controller coupled to the sensor to capture a fingerprint image. In at least some configurations, a mask layer is provided. The mask layer can be positioned such that it has an upper surface adjacent the protective layer. Additionally, the conductive layer can be positioned such that it is disposed on a bottom surface of a mask layer and positioned on a lower surface of the protective layer. The mask layer can further include an indication, such as an aperture in the mask, of a fingerprint sensing area. In some aspects one or more controllers can be provided and further can be in, but are not limited to, a chip-on-flex configuration.

Additionally, the sensor can be configured such that it comprises at least one conductive layer. Conductive layer(s) can be formed from transparent or at least translucent materials, such as materials selected from one or more of indium tin oxide, carbon nanotubes, metal nanowires, conductive transparent polymers and fine line metal. Additionally, the conductive layer can be formed from a flexible material. In at least some configurations, or more of each of a planarization layer, an optical coating, an optically clear adhesive, a clear plastic film, and a hard coat can be provided. Suitable material for the protective layer may be selected from the group comprising ultra thin glass and polyethylene terephthalate. Furthermore, in at least some configurations, a hard coating may be applied to the protective layer. Additionally, the fingerprint sensor can further be configurable to comprise a conductive layer and the touch sensor can be configurable to further comprise a conductive layer and further wherein the conductive layer of the fingerprint sensor and the conductive layer of the touch sensor may be integrally formed.

An additional aspect of the disclosure is directed to a method of assembling an integratable device, component and/or housing.

Yet another aspect of the disclosure is directed to a method of authenticating biometric information. A method according to the disclosure may comprise: identifying a housed sensor positionable within 250 microns of an uppermost surface of an electronic device, and a controller coupled to the sensor to capture a fingerprint image wherein the controller is positionable at least one of within the housing or within the electronic device, sensing biometric information associated with a user; comparing the sensed biometric information with a biometric template associated with the user; if the biometric information matches the biometric template, releasing credentials associated with the user based on the biometric information, and communicating these credentials to a requesting process.

Additionally, aspects of the disclosure include: identifying a housed sensor positionable within 250 microns of an uppermost surface of an electronic device, and a controller coupled to the sensor to capture a fingerprint image wherein the controller is positionable at least one of within the housing or within the electronic device; identifying a biometric device installed in a client device with a web-enabled application; identifying biometric information associated with a user; creating a biometric template associate with the biometric information; releasing user credentials associated with the user; and binding the user credentials with the biometric template.

It will be understood by those skilled in the art that a method and system is disclosed which may comprise a biometric object sensor comprising: at least one conductive layer formed from one of a transparent or translucent material and formed in at least one of on or in or under an outer layer of a user device housing; at least one of a transmitter trace and at least one of a receiver trace formed from the at least one of the transparent or translucent material in the conductive layer. The transparent or translucent material may form at least a portion of a touch screen display on a user device. The at least one of a transmitter trace and at least one of a receiver trace may comprise one of a plurality of transmitter traces and a receiver trace formed on the sensing surface and a plurality of receiver traces and a transmitter trace formed in or on the touch screen display or one of a plurality of transmitter traces and formed in or on the touch screen display and a plurality of receiver traces formed in or on the touch screen display and separated from the transmitter traces by a dielectric material. The plurality of transmitter traces and receiver traces may be formed to define a plurality of transmitter/receiver crossover pixel positions.

The biometric sensor apparatus and method may comprise a fingerprint on a finger of a user. The biometric sensor and method may comprise the transparent or translucent material being selected from a group containing indium tin oxide, carbon nanotubes, metal nanowires, conductive transparent polymers and fine line metal.

The biometric sensor apparatus and method may comprise a sensor housing that may comprise a sensor substrate that may comprise at least one of a transmitter trace and a receiver trace formed on a sensing surface of the sensor substrate; the sensor housing contained within a user device may comprise a user device housing and an outer surface of the user device housing; and the sensor housing contained within the user device housing with at least the sensing surface of the sensor positioned within a biometric sensing distance of up to 250 μm from one of an outer surface of the user device housing and an opening in the user device housing. The at least one of a transmitter trace and at least one of a receiver trace may comprise one of a plurality of transmitter traces and a receiver trace formed on the sensing surface and a plurality of receiver traces and a transmitter trace formed on the sensing surface.

The at least one of a transmitter trace and a receiver trace may comprise a plurality of transmitter traces formed in the sensor substrate or on the sensor substrate and a plurality of receiver traces formed in the sensor substrate or on the sensor substrate and separated from the transmitter traces by a dielectric material. The plurality of transmitter traces and receiver traces may be formed to define a plurality of transmitter/receiver crossover pixel positions. The biometric may comprise a fingerprint on a finger of a user. The sensor substrate may comprise a flexible material. The biometric sensor and method may comprise at least one of a planarization layer, an optical coating, an optically clear adhesive, a clear plastic film, and a hard coat. The sensing surface of the sensor substrate may be covered by a layer protective layer selected from the group that may comprise an ultra-thin glass and polyethylene terephthalate.

A method of authenticating biometric information is disclosed which may comprise: utilizing a housed sensor contained within a housing of a user device and comprising at least one sensor trace positioned within 250 microns of an uppermost surface of the user device; sensing biometric information associated with a user using the at least one sensor; comparing the sensed biometric information with a stored biometric template associated with the user; and releasing at least one credential of the user if the biometric information matches the stored the biometric template. The method may comprise transmitting the credentials to a remote authentication requesting processor.

### INCORPORATION BY REFERENCE

All publications, patents, and patent applications mentioned in this specification are herein incorporated by reference for all purposes and as if the entire individual reference, including, e. g., the specification, claims and drawing were repeated here in total, and to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1 and 1A illustrate, partly schematically, a one layer design for a 2D static sensor, formed on a single substrate, e.g., on one side of a single substrate, according to aspects of embodiments of the disclosed subject matter;

FIGS. 2A-2B illustrate partly schematically, the sensor construction of the sensor shown in FIGS. 1 and 1A;

FIG. 2C shows a blown up view of a portion of the sensor illustrated in FIGS. 1, 1A, 2A, and 2B;

FIGS. 3A-D illustrate a two layer design for a 2D sensor according to aspects of embodiments of the disclosed subject matter;

FIGS. 4A-C illustrate schematically two layer substrates attached with an anisotropic connective film (“ACF”) design;

FIG. 5 illustrates schematically a 2D sensor stack-up according to aspects of embodiments of the disclosed subject matter;

FIGS. 6A and 6B illustrate schematically other variations of the stack-up sensor arrangement illustrated in FIG. 5;

FIG. 7 illustrates schematically a 2D sensor arrangement according to aspects of embodiments of the disclosed subject matter;

FIG. 8 illustrates schematically an alternative embodiment of the 2D sensor transmitter array and receiver array as illustrated in FIG. 7.

### DETAILED DESCRIPTION OF THE INVENTION

A variety of electronic displays are used with electronic devices. Displays can operate using either emissive (pixels generate light), transmissive (light transmitted through pixels) and reflective (ambient light reflected) approaches. Display types may include, for example, liquid crystal displays (LCDs) which use liquid crystal cells that change in transmission or reflection in an applied electric field, organic light emitting diode (OLED) devices which utilize a light emitting diode (LED) in which an emissive electroluminescent film of organic compounds emits light in response to the application of an electric current, and different types of electrophoretic displays in which pigmented particles are moved in response to an electric field (e.g. Gyricon, E-ink, etc.).

Gyricon is a type of electronic paper developed at Xerox PARC and is a thin layer of transparent plastic in which millions of small beads are randomly disposed. The beads, somewhat like toner particles, are each contained an oil-filled cavity and are free to rotate within those cavities. The beads are bichromal with hemispheres of two contrasting colors and charged such that they exhibit an electrical dipole. When voltage is applied to the surface of the sheet, the beeds rotate to present one of the two colors to the viewer. Thus voltages can be applied to create images such as text and pictures. E-ink is another type of electronic paper manufactured by E Ink Corporation which was acquired by Prime View International.

An LCD panel typically consists of two sheets of glass separated by a sealed-in liquid crystal material. Both sheets have a thin transparent coating of conducting material, with the viewing side etched into segments with leads going to the edge of the display. Voltages applied between the front and back coatings disrupt the orderly arrangement of the molecules sufficiently to darken the liquid and form visible patterns. An LCD touch screen typically is an assembly that includes an LCD, a printed circuit board (PCB) on which input-output (I/O) connections and integrated circuits (ICs) performing various functions are mounted, a transparent touch screen circuit pattern on a transparent substrate, and a protective shield or coating applied on top of the touch screen circuitry.

The touch screen circuitry is connected along with the LCD display to the PCB. The touch screen circuitry is typically incorporated into the assembly using one of two methods. In a first method, the touch screen circuitry is incorporated directly into or onto the LCD, then a protective shield or coating (e.g. cover lens) is located above the LCD/Touch screen combination. In a second method, the touch screen circuitry is applied onto the protective coating or shield (e.g. cover lens) and then the resulting structure is mounted above the LCD, with the touch screen circuitry mounted between the protective coating or shield and the LCD. In all such cases the PCB is located below the LCD, and, thus, out of view.

Additionally, displays have been developed that can detect the presence and location of touch, e.g., by a finger, or by a passive object such as a stylus or digital pen, are commonly referred to as a touch screens. Touch screens have become a component of many computer and electronic devices. Many LCD displays are manufactured to include touch screen functionality. Touch screens can be attached or incorporated into computers, networks, mobile telephones, video games, personal digital assistants (PDA), tablets, or any digital device. A variety of technologies are currently used to produce a device with touch screen capabilities.

Technologies that enable touch screen functionality include: resistive touch screen panels; surface acoustic wave technology; capacitive sensing panels (e.g., using surface capacitance technology or projective capacitive touch technology, which uses either mutual capacitive sensors or self-capacitive sensors); infrared; optical imaging; dispersive signal technology; and acoustic pulse recognition. Touch screen functionality can be combined with a display in a device in many configurations. The touch screen sensing circuits can be incorporated directly in or on the layers of the display (using, for example, “in-cell” or “on-cell” approaches), built on a separate substrate which is laminated onto the display (e.g., using an “out-cell” approach), or laminated on a cover lens which protects the display in the device, or the sensing circuits can be incorporated directly on the back-side of this cover lens (“Touch-on-Lens”).

As will be appreciated by those skilled in the art, electronic devices can be configured to include a variety of components and features including: a display, a touch screen, a scratch-resistant cover (e.g., lens), storage, a system on a chip, a CPU core, a GPU core, memory, Wi-Fi connectivity (e.g., 902.11 e.g), Bluetooth, connectivity (e.g., USB connector), camera, audio, battery (e.g., built-in, rechargeable lithium-ion polymer battery), power connector, computer readable media, software, etc.

Additionally electronic devices and displays can be configured to include, for example, a button or form factor for user interaction (e.g., power on and off, volume change, etc.). Buttons can be provided and/or integrated in a device housing or be included as part of a device screen or simulated, emulated or functionally duplicated in the imaging displayed on the screen.

Biometric sensors can include, for example, a fingerprint sensor, a velocity sensor, and an integrated circuit which can be electrically connected to the fingerprint sensor and the velocity sensor. Conductive traces of an image sensor and velocity sensor can be etched or printed or otherwise formed on an upper side of a substrate. A protective coating can be applied to the upper surface of the substrate, over the image sensor and velocity sensor to provide electrical isolation and mechanical protection of the sensor elements of the sensor. Alternatively, conductive traces of an image sensor can be formed as the sensor elements on a bottom-side of a substrate, wherein the substrate can act as a protective coating and can be further improved with a hard coating applied to the upper/outer surface. Further details about fingerprint sensor configurations are contained in, for example, U.S. Pat. No. 7,751,601 to Benkley III for “Fingerprint Sensing Assemblies and Methods of Making”; U.S. Pat. No. 7,099,496 to Benkley III for “Swiped Aperture Capacitive Fingerprint Sensing Systems and Methods;” U.S. Pat. 7,463,756 to Benkley III for “Finger Position Sensing Methods and Apparatus;” U.S. Pat. No. 7,460,697 to Erhart et al. for “Electronic Fingerprint Sensor with Differential Noise Cancellation;” U.S. Pat. No. 7,146,024 to Benkley III for “Swiped Aperture Capacitive Fingerprint Sensing Systems and Methods;” U.S. Pat. No. 6,400,836 to Senior for “Combined Fingerprint Acquisition and Control Device;” and U.S. Pat. No. 6,941,001 to Bolle for “Combined Fingerprint Acquisition and Control Device.”

In the systems disclosed in the present application, a biometric sensor, such as a fingerprint sensor, can be made to be integrated or integratable with a display and can be positioned on or adjacent the uppermost surface such that at least the sensor elements of the fingerprint sensor are within about 250 microns of a finger when the finger comes in contact with the uppermost surface of the system. In at least some configurations, the system can be configured such that at least the sensor elements of the finger sensor are configured to be positioned within about 200 microns of a finger, more preferably within 150 microns, still more preferably within 100 microns, or even more preferably within 50 microns of a finger, when the finger comes in contact with the uppermost surface of the system. In at least some configurations, the system can be configured such that at least the sensor elements of the finger sensor are configured to be positioned more than 50 microns away from a finger, more than 100 microns away from the finger, more than 150 microns, and in some configurations more than 200 microns from a finger surface when the finger comes in contact with the uppermost surface of the system.

In some configurations, a single chip can be provided that controls one or more of the display, touch screen and the fingerprint sensing functions. Additionally, the sensor can be incorporated in such a way that the surface of the device presented to a user is smooth or substantially smooth. Displays and systems can be configured such that they are integrally formed such that they act in a unified manner or such that the completed display or system is comprised of a single component. In other configurations, two chips can be provided that control one or more of the fingerprint sensing functions. This would allow the digital (transmit function) to be separated from the analog (receive function), thus allowing separate packaging for the two elements. This configuration allows the transmit and receive functions to be on separate metal layers of a sensing element, thus simplifying the connection schemes required to connect the silicon to its corresponding array element.

The configurations provided enable the use of a double-sided flex (e.g., with copper traces on each side). An electrode array can, for example, be fabricated on two different circular paddles or pads which are part of a single flex circuit. The arrays additionally can be configured such that they are conductive traces with a pitch from 30 to 100 microns. Additionally, the circular area can be sized to correspond to, for example, a button shape. A flex located near the top of the button within, for example 400 μm, 200 μm or 100 μm of the surface where the finger is applied to the button can also be included. The paddles can then fold-over onto each other and laminate to each other to allow two overlapping arrays of electrodes at right angles to each other (e.g., X-Y pattern). One array is typically for transmitting signals while the other array is typically for receiving signals. The receivers typically work on a differential concept. For example, two of them can be read while the difference between the signals is used to generate data. Firing one transmitting line, and receiving on two of the receiving lines can also be used to define a pixel location near the intersection of where the receivers overlap the transmitters. In another configuration, the receivers typically work on a single ended concept. For example, one of them can be read while the others are static. Firing one transmitting line, and receiving on one of the receiving lines can define a pixel location near the intersection of where the receiver overlaps the transmitter. To eliminate noise, the receiver can take several samples and the sample data can be averaged.

Using a double sided array can enable a compact routing of signal lines that will transmit I/O signals to and from the array. The signal lines may also be configured to pass through the flex substrate along the way, in order to minimize the area of these routes within, for example, a button area profile. The flex substrate may be polyimide or similar dielectric material used for electrical flex circuitry, such as Kapton® tape and may be from, for example, 6 microns to 50 microns in thickness.

For example, U.S. Pat. No. 7,099,496 illustrates the layout and operation of a one dimensional linear capacitive gap impedance passive impedance interference effect biometric image sensor, such as a fingerprint image sensor. Such a linear capacitive gap sensor array operates by activating a line of conductive drive plates individually with a probing signal, and reading the resulting received version of the probing signals output on a common pickup plate in time with the transmitter/drive plate activation. The electric field which is coupled across a gap between an active drive-plate to the pickup-plate defines an individual pixel location. The characteristics of the resulting pickup signal will depend primarily on the impedance between the respective drive plate and the pickup plate(s) across the pixel location gap. The difference in impedance that is caused by whether a fingerprint ridge or valley is located within the pixel gap can be detected by differences in the pickup signal and translated into an image of the ridge or valley at the pixel location for a given linear scan, a plurality of which make up the image of a fingerprint or at least a portion of such an image, e.g., in the direction of the movement of the swiping finger being scanned by the linear array.

Such a biometric image sensor can further comprise a 1D or 2D array of capacitive sensors for capacitive sensing of ridge peaks and ridge valleys of a fingerprint on a stationary or moving finger; a finger sensor for sensing, for example, the speed of a finger as it moves across the image sensor or the presence of the finger on the image sensor, wherein the image sensor and the finger sensor may be fabricated on a single substrate; a sensor circuit, separate from the substrate, for operating the image sensor and the finger sensor to provide biometric image data, e.g., fingerprint data; and wherein the image sensor, in some embodiments, may further comprise: an image pickup plate disposed generally laterally and a plurality of image drive plates in spaced relation to the image pickup plate to define a plurality of sensor gaps between respective image drive plates and image pickup plate.

The difference of a finger ridge or valley present over the gap forming the pixel location can result in detectable differences in the output signal from the pickup plate(s). These in turn can be used to build an image of the portion of the finger close to the sensor array, as an example, a linear 1 X n pixel array image forming part of the image of a fingerprint in one example. A line scan can be achieved by driving the drive plates sequentially, one after the other, and a linear image of the finger surface can thereby be created. If a finger is swiped in a direction generally orthogonal to the line of pixel location gaps, multiple scans can be taken and arranged to create a full fingerprint image or at least a portion of the image.

A sequence of activation, as an example, can involve successive groups of drive plates being activated, as an example, all with the same number of plates in the same pattern. Note that different groups may overlap and contain some of the same drive plates. As with the original sensor described above, the sequence does not necessarily require that adjacent groups follow each other: the sequence can involve any order of activation so long as the resulting data is organized as needed for analysis. When the data is organized, the signal levels of adjacent groups can then be compared. Note that adjacent groups would still be only a distance P apart, as with the original image sensor described above, where P is the pitch of the individual traces. Thus, even though the size of a group is larger than W, the width of a single trace, the pitch between them would still be P. Thus, the signal may be increased by proper grouping of the drive plates while not necessarily increasing the pitch. Since the signal level and device resolution are no longer directly coupled, it is possible to improve signal size at a given resolution compared to the method of activating the drive plates sequentially.

As a generalization, the resolution of such a linear sensor array can be determined by the pitch, P, (distance from one point on a sensor drive plate to the same point on another adjacent sensor drive plate along the length of the line of the drive plates). Resolution may be defined by the number of pixels per a given length, L (or resolution=P/L). The finger may not directly contact the drive plates, but may be separated from them by a distance. This distance d may be, e.g., the thickness of a protective coating. The strength of signals and their changes due to changes in the finger surface at the individual pixel locations, can depend critically on the overall capacitance determined by the local geometry of the finger surface, the drive plates and the pickup plate(s). As d is increased, this capacitance coupling with the finger surface can be expected to decrease, resulting in an overall output signal reduction.

Arrays can be designed within a circumference of a round shape for use with, for example, a round button. As will be appreciated by those skilled in the art, other shapes can be used. Additionally, the electrodes need not be straight lines as depicted. Additional shapes and configurations can be used to help define pixel location and to optimize the signal.

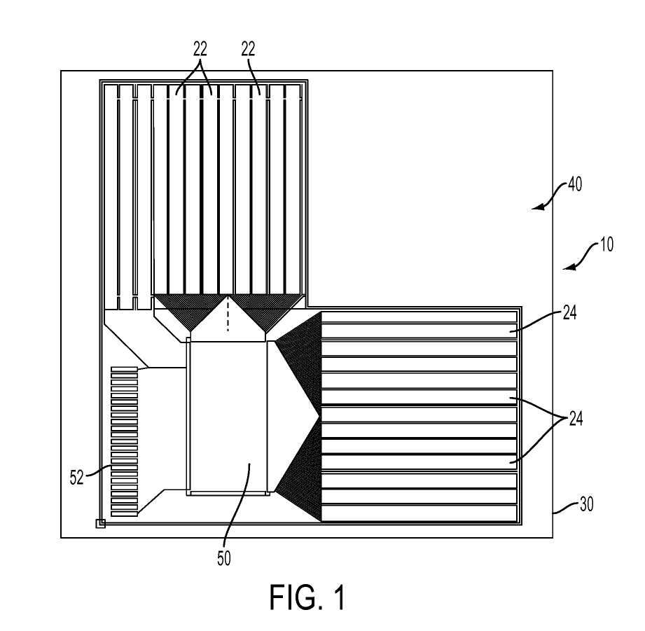

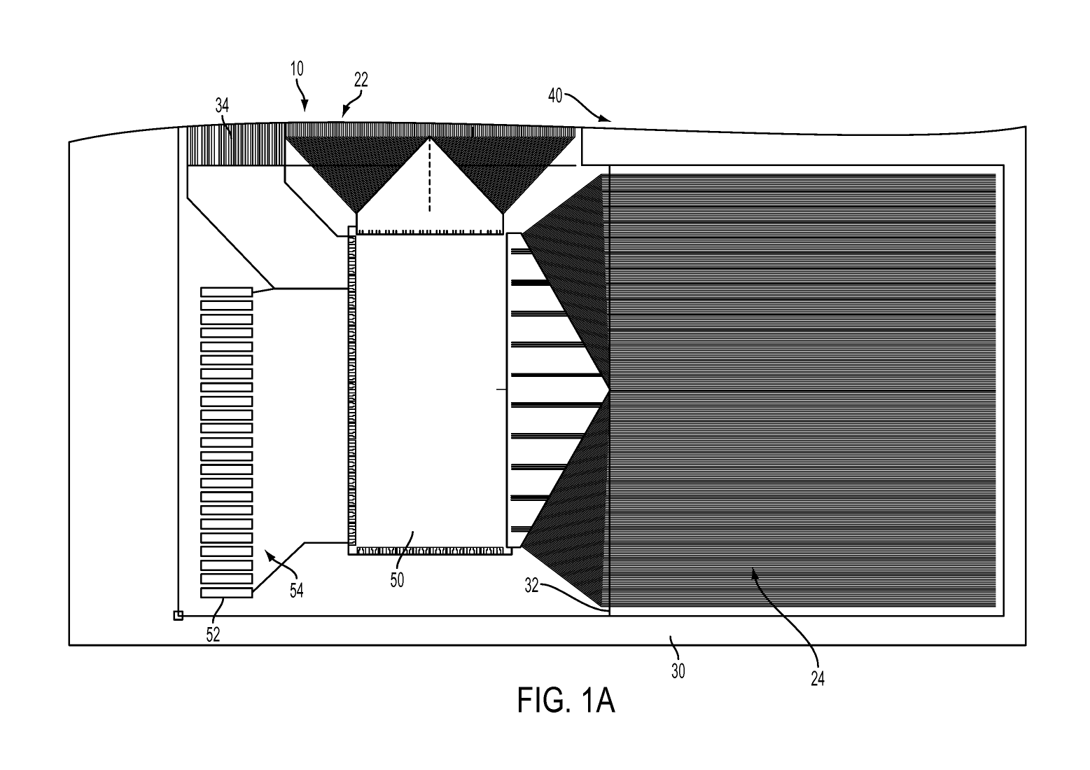

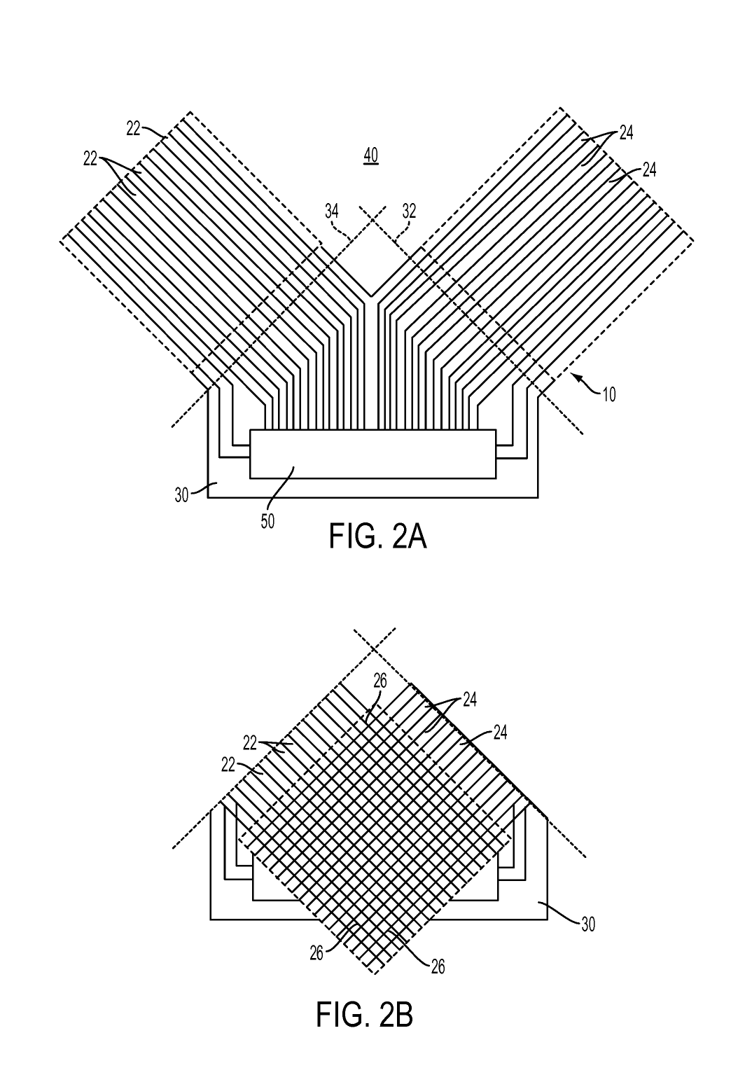

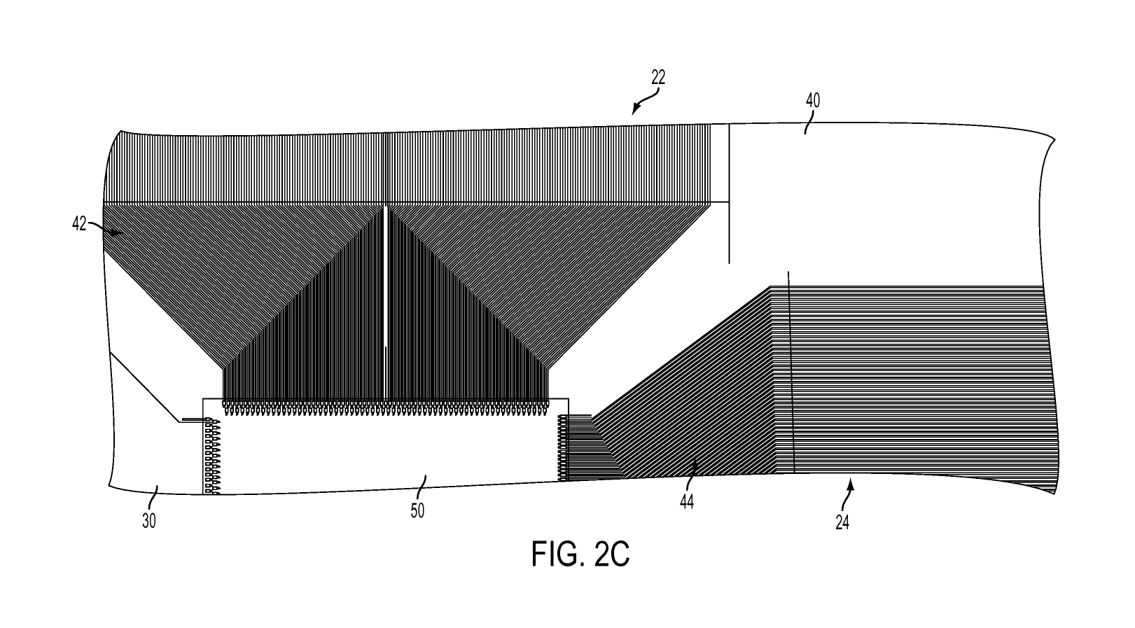

FIG. 1 and FIGS. 2a-b illustrates a one layer design for a 2D static sensor 20. As shown in FIG. 1, all transmitter traces 22 and receiver traces 24 are formed on a single layer, e.g., a layer of Kapton® tape flex material 30 having an x axis and a y axis. The generally square portion 40 of the flex material 30 may be removed and the portion of the layer with the transmitter traces 22 folded toward the bottom of FIG. 1 and the portion of the layer 30 having the receiver traces 24 on it folded to the left of FIG. 1, thereby, when so folded form pixel locations 26 at the crossover points of the transmitter traces 22 and the receiver traces 24. It will be understood that the transmitter traces 22 and receiver traces 24 in FIGS. 2A and 2B are shown schematically, as many more crossover pixel locations would be formed than shown, e.g., a 200X200 matric grid array or 150X200 matrix grid array. Either one of the sensor traces 22, 24 forming the pixel location crossover pads 26 can be a transmitter (Tx) or a receiver (Rx).

When the flex material 30 is folded along the fold lines shown in FIGS. 2A and 2B, the transmitter (Tx) traces, 22 as illustrated in FIGS. 2A and 2B are perpendicular to the receiver (Rx) traces 24, resulting in the 2D grid array sensor shown in FIG. 2B. As will be appreciated by those skilled in the art, the transmitter/receiver crossover pixel locations 26 can be formed by folding the flex material 30 in many different ways depending on the desired structure. For example, the flex material 30 can be folded first along the fold line associated with the transmitter traces 22, and then along the fold line associated with the receivers 24 or vice versa. Moreover, the folds can be into or out of the page as shown in FIGS. 2A and 2B.

Additionally, the pads can take on a variety of shapes and forms without departing from the scope of the disclosure. Shapes include, but are not limited to button, round, square, oval, ovoid, rectangular, etc. In some configurations there may be more than two pads which require folding. It will also be appreciated that in some instances, e.g., the folding illustrated in FIGS. 2A and 2B, an appropriate dielectric along with or incorporating an adhesive may be applied between surface of the flex material containing the transmitter traces 22 being folded and such traces 22 on the surface of the flex material 30 which is not being folded, e.g., sensor input/output (“I/O”) contacts 52 and traces 54 leading to an controller IC 50, to insulate the transmitter traces 22 from such other transmitter traces 22 and/or other connections to the controller IC 50. However, the reverse side of the flexible material 30 from that on which the transmitter traces 22 are formed can serve to insulate the receiver traces 24 from the transmitter traces 22 forming the above discussed 2D matrix grid array and the receiver traces on the unfolded portion, and/or other traces leading to the controller IC 50. Therefore only an adhesive layer may be needed for the interface between the folded portion with the transmitter traces 22 and the folded portion with the receiver traces 24.

FIG. 1A illustrates a 2D sensor 10 with an array of receiver traces 24, where the array of transmitter (Tx) traces 22 is in a first direction, extending toward the top of FIG. 1A, and truncated for clarity purposes, while the array of receiver (Rx) traces 24 is in a second direction, shown perpendicular to the first direction, i.e., extending to the right in FIG. 1A. FIG. 1A can be seen to illustrate a blown-up view of the 2D sensor 10 shown in FIG. 1. FIG. 2C illustrates further blow-up of a 2D sensor 10 illustrating the integrated circuit (IC) 50 connection with a 363 dot per inch (“DPI”) layout of transmitter Tx traces 22 (truncated for clarity) and receiver Rx traces 24 through respective fan-outs 42 and 44 from the pitch of the IC 50 I/O pins. As will be appreciated by those skilled in the art, the flex fan can be any DPI desired. A fan-out to 363 DPI is depicted for purposes of illustration only. It will also be understood that a fan-out to 363 DPI for the transmitter (Tx) traces 22 and the receiver (Rx) traces equals a 2D grid array of approximately 132 K dots (Tx/Rx crossover points, i.e., pixel locations) per square inch on the image sensor 2/D grid array.

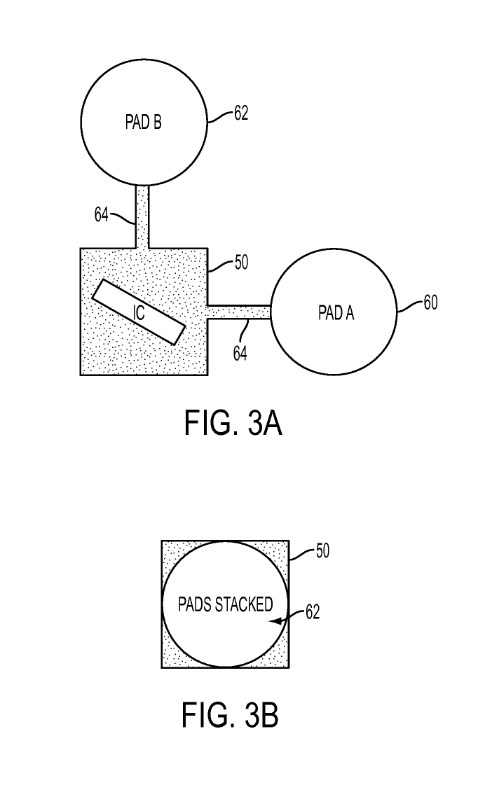

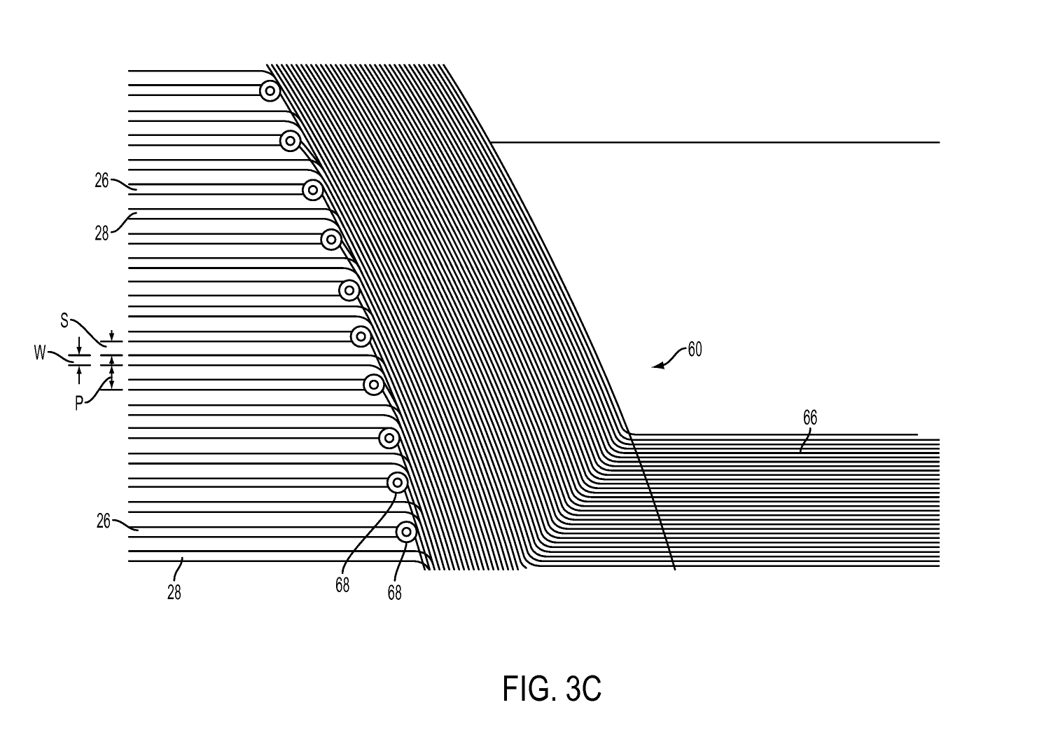

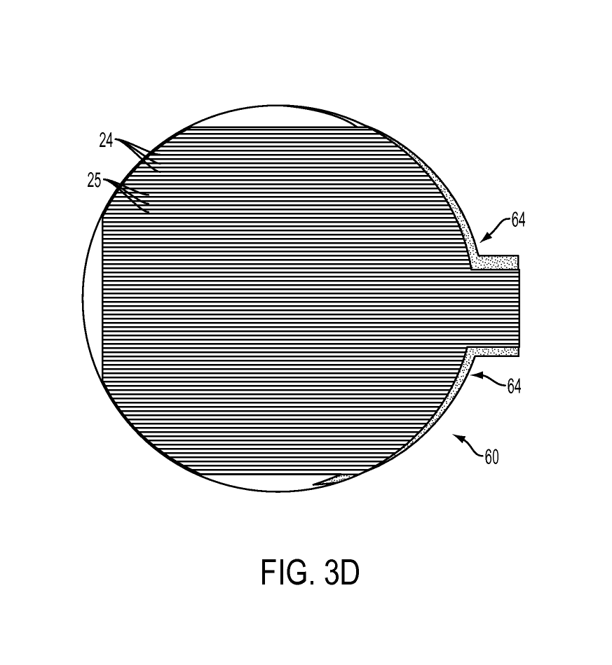

FIGS. 3A-C illustrate a two layer design for a 2D sensor. As shown in FIG. 3A, pad A 60 and pad B 62 extend from the controller integrated circuit 50. Either pad A 60 or pad B 62 can be formed with transmitter (Tx) traces 22 or receiver (Rx) traces 24. As shown in FIG. 3B, the pads 60, 62 can be folded in towards the IC 50 such then when folded, the pads are stacked. FIG. 3C, illustrates an expanded view of either pad A 60 or pad B 62. As will be appreciated by those skilled in the art, the traces can be on multiple layers and the layers can be folded to form transmitter/receiver crossover point pixel locations 26. Additionally, pixel density for the sensor (DPI) will be understood to vary depending upon the transmitter (Tx) traces 22 and receiver (Rx) traces 24 spacing. The insulating and adhesive layer(s) as discussed above will be apparent to those skilled in the packaging art. Silicon can also be seen to be independent of and insulated from the sensor traces forming the 2D matrix grid sensor array.

FIG. 3C illustrates a multi-layer array of receiver (Rx) lines 26 and 28 such as may be formed on a pad 60, 62. As depicted, the basic layout can be formed on a single substrate, w.g., a flex substrate to form lines on both sides of the flex material. Every other trace 26 formed as a fan-out of traces 66 coming from, e.g., a controller IC 50 may be routed to the opposite side of the flex substrate, e.g., through vias 68. The layered array of, e.g., receiver (RX) traces may therefore be formed to have a width W of 25 μm, and a pitch P of 70 μm, i.e., the spacing between traces being, in this example, 45 μm. With every other line routed to the bottom side of the flex substrate, as seen in FIG. 3C, the signals picked up by adjacent traces 26, 28 or adjacent groups of traces may be used as differential signals for, e.g., noise reduction purposes as is known in the art. As will also be appreciated by those skilled in the art, the transmitter pad 60, 62 may be similarly formed adding further available differential to the received signals of may have all traces on a single side of the pad 60, 562. Further those skilled in the art will appreciate that a flexible substrate can be used or a rigid substrate can be used. For example the transmitter (Tx) traces 22 or the receiver (Rx) traces 24 could be formed on a flexible substrate as shown in FIGS. 3A-C while the opposite receiver (Rx) traces 24 or transmitter (Tx) traces can be formed on a rigid substrate (not shown).

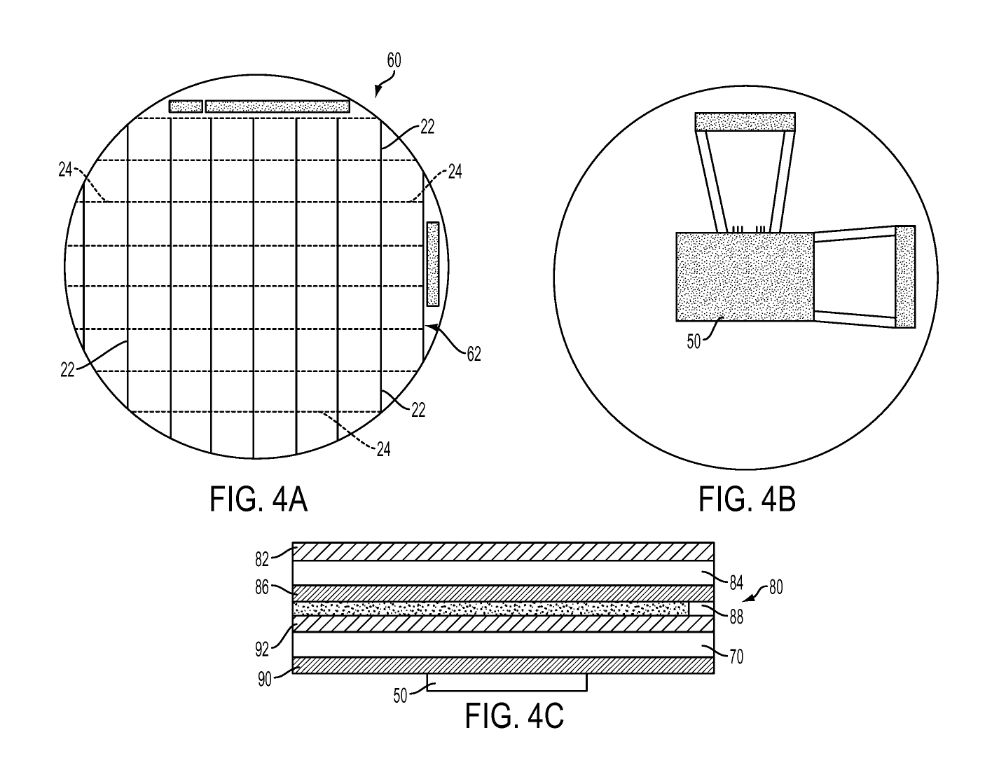

FIGS. 4A-C illustrate separate two layer substrates attached with an anisotropic conductive film (ACF) design. As shown in FIG. 4A, a sensor array, illustrated schematically and not to scale, can be created from the overlap of top metal (solid lines) and bottom metal (dotted lines). One set of metal lines can be the transmitter (Tx) traces 22 and the other set can be the receiver (Rx) traces 24. Turning to FIG. 4B, an IC 50 can be positioned on a silicon substrate 70. FIG. 4C illustrates a sample stack-up 80 with a top metal layer 82 or protective layer, the sensor pad 84, a bottom metal layer 86, and an adhesive layer 88. An ACF layer 88 can be provided as well, if desired. Thereafter a top metal layer 82 is provided on a silicon substrate, with a bottom metal layer 86 connected to the IC 50. In other configurations, the sensor pad and silicon substrate can be connected by a loop in the flex material.

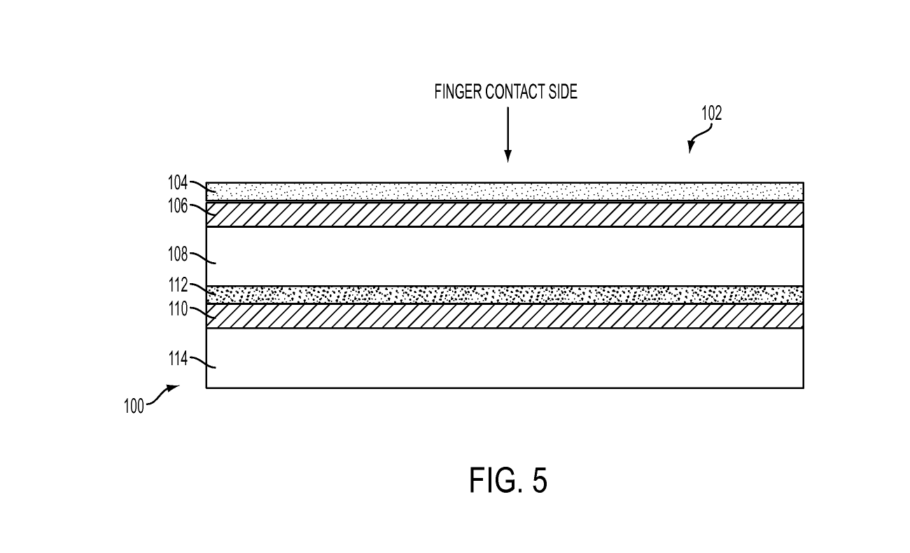

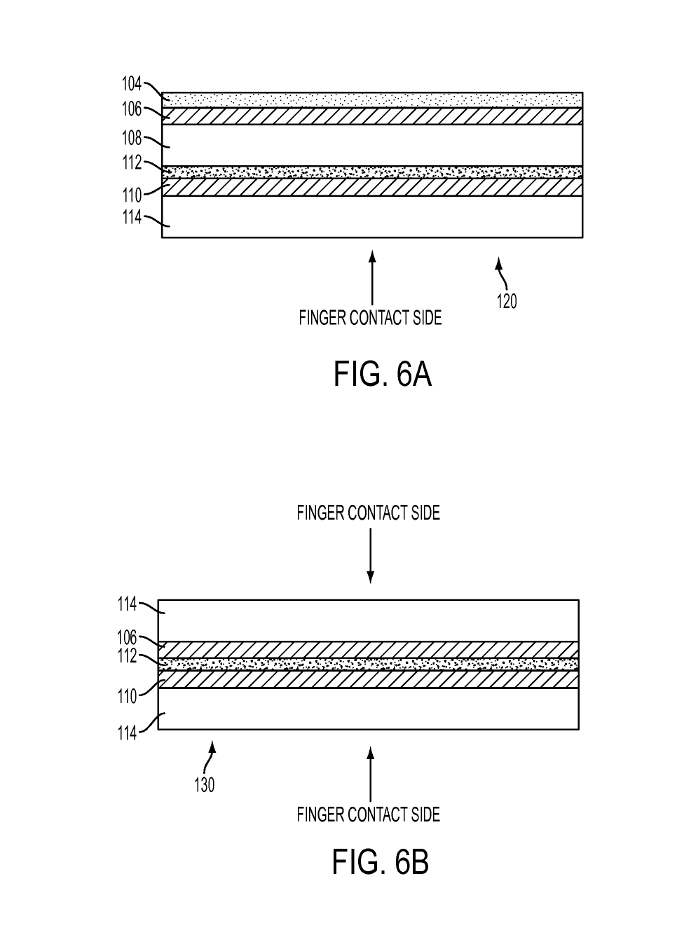

FIGS. 5 and 6A-B illustrate a 2D sensor stack-up. FIG. 5 illustrates a 2D sensor stack-up 100 illustrating a stack-up 100 that could occur when tabs 64 are folded. The first layer adjacent a finger contact side 102 can be a protective layer 104 or top coat. The protective layer 104 can be any of a variety of materials which protect the underlying layers. Protective layers include, but are not limited to glass, Kapton®, ink, paint, or solder resist material. Additionally, the protective layer 104 can be a suitable non-conductive material. The protective layer 104 is shown to be adjacent a metal layer 106, which is adjacent, for example, a layer 108 of Kapton® tape, which is adhered to a second metal layer 110 via an adhesive layer 112. A Kapton® base film 114 can also be provided. FIGS. 6A-B illustrate alternative stack-up arrangements.

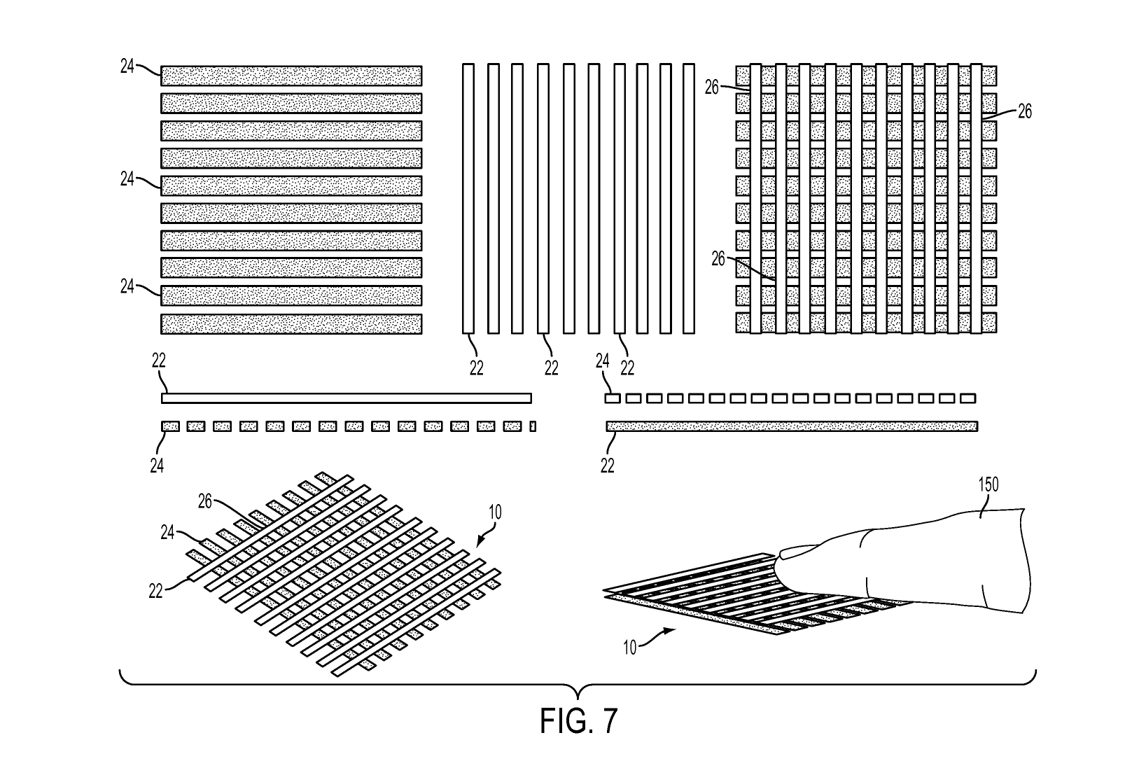

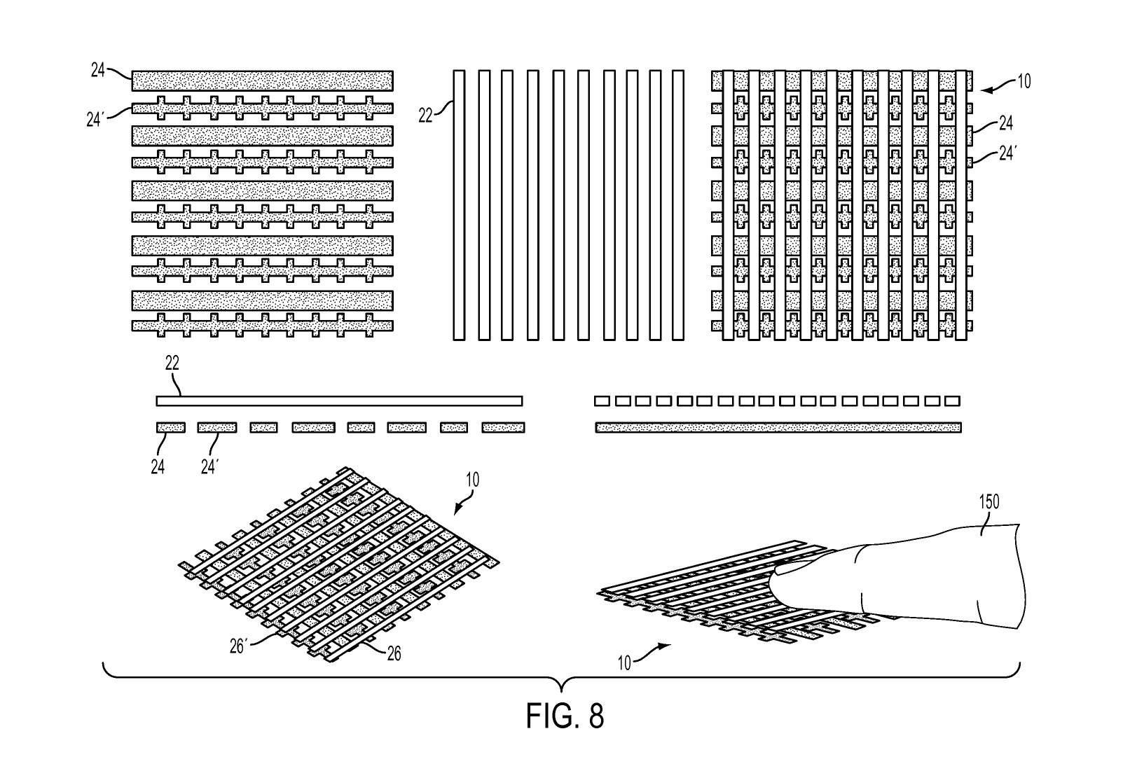

FIGS. 7 and 8 illustrate 3D schematic views of disclosed sensors such as those illustrated partly schematically in FIGS. 1, 1A, 2A-C and 3A-D. The traces 22 on Pad A can be receiver (Rx) traces 24 and the traces on Pad B can be transmitter (Tx) traces 22. Pad A and B can be layered upon each other such that there is a layover 10 of pad A and pad B, which can form a 2D grid array sensor 10. The sensor 10 may have a first side view on the left in FIG. 7, looking from the left or right side of FIG. 7 and a second side view as shown on the right in FIG. 7, looking from the top or bottom of FIG. 7. A finger 150 can be positioned on one side of the stack-up 10.

In such a sensor array 10, the transmitters can be modeled as being attached to electrical ground of some other neutral reference plane, with at least one transmitter 22 switching to a transmission mode at any given time. That is, up to a 25 Ohm impedance to ground may be seen. Additionally, the switched on transmitter(s) 22 can be transmitting a square wave from 0 to 3.3 volts at radio frequency (“RF”), i.e., as an example, 25 MHz. The frequency can also be, for example, 16 MHx, 18 Mhx, 19.2 MHz, 21 MHz or 24 MHz. Additionally, receivers 24 are typically modeled as floating but can also be modeled such that a 5k impedance to ground at, for example, 24 Mhz, is present. The finger can be modeled as a dielectric for both the dry finger and the wet finger. It will also be understood that, as noted above, a dielectric/adhesive layer(s) may intervene between the transmitter (TX) traces 2 and the receiver (Rx) traces 24.

Cell phones and tablets devices are using various forms of very high gloss substrates as the cover for their products. These substrates are often materials such as glass, gorilla glass, clear plastic, acrylic, or any other high gloss surfaces. In order to fit into these housings, the finger print sensor must also have a very high gloss surface to match the surrounding surfaces of these products. According to aspects of the disclosed subject matter methods for producing such a housing for finger print sensor products are proposed. The first step of the process is to determine the button top surface material. The material can be glass, plastic, acrylic, or any other clear protective surface. The top surface material is coated on the underside with any form of coloring agent including ink, top coat material, colored epoxy, etc. Adhesive can be placed on the coloring agent. A bezel of some form (molded plastic, formed metal, etc.) may be used to form the outer shape of the button. The bezel can be attached to the adhesive which resides on the coloring agent on the top surface material. The finger print sensor can then be attached to the adhesive on the coloring agent of the top surface material, e.g., inside the cavity of the bezel. The cavity can then filled with any form of fill material to complete the button. Electrical connection can be made via a flex connector. This method can allows the button to take on any shape required by the customer, as the top material and housing maybe shaped to order.

In at least some configurations, the packaged finger print sensor would achieve an aesthetic look and feel which would align with the housing into which it is being placed (typically glass, gorilla glass or acrylic). It would offer higher durability for scratch resistance since the coloring agent is placed on the bottom side of the top material and not be touched by the finger or the external environment. Because the outer body is formed by a molded plastic, the button may take on different shapes such as round, pill, or various other button shapes.

Electronic devices typically include a housing, a printed circuit board (PCB) and a display, such as an LCD or LCD module. The electronic devices can also include a touch sensor component, such as a glass layer, onto which a conductive layer such as indium tin oxide (ITO) or similar materials are applied to form the touch screen circuitry. The conductive layer can be applied such that it forms a pattern on the surface of the glass layer, as will be appreciated by those skilled in the art. A first conductive layer can be configured to cover, for example, an upper surface of the touch sensor component while a second conductive layer covers a lower surface of the touch sensor component A cover lens can be formed from suitable material including, for example, a chemically hardened glass. A touch circuit controller can be coupled to a touch screen circuit or digitizer which can be formed from conductive layers of the touch circuit components via a flexible circuit.

A fingerprint sensor senses fingerprint characteristics of a finger held or positioned on the surface of a protective layer proximate the fingerprint sensor. The protective layer and display layer can be formed from any suitable non-conductive material (e.g., glass, PET or a suitable hard coating). A fingerprint sensor can be is adapted and configured such that it is capable of sensing ridges and valleys of a user's finger at or within a target distance from the device surface. The target distance, as an example, may be less than 250 microns, more preferably within 200 microns, even more preferably within 150 microns, still more particularly the distance may be less than 100 microns, and even more particularly is less than 50 microns. In at least some configurations, the target distance can be more than 50 microns, more than 100 microns, more than 150 microns, and more than 200 microns.

The flex section may be adapted and configured to electrically engage the conductor and a suitable integrated circuit (IC), application-specific integrated circuit (ASIC) or chip.

As will be appreciated by those skilled in the art, wrap-around leads in a direct build-up approach of a fingerprint sensor can be used. A protective layer such as a hard coating may be is positionable over a mask. A planarization layer can also be provided which is positioned over a patterned conductive layer. The cover lens can be configured such that it has a conductive lead wrapped around an end which engages a flex connector having connector traces leading to a chip via an anisotropic conductive film (“ACF”).

In other configurations, a wrap-around lead can be used in an ultrathin glass approach of a fingerprint sensor. A protective layer such as ultrathin glass can be provided which covers a mask. A patterned conductive layer can be positioned over an optional optical coat. A cover lens of a display can be provided which can have a wrap-around lead printed thereon. The lens can be adhered to the optical coat (if present), the patterned conductive layer, the mask and the ultrathin glass via an adhesive. A flex substrate having a chip on it can be connected to the wrap around leads of the cover glass or lens via an ACF.

In still other configurations, thin glass and a transparent flex can be used. A thin glass layer can be provided as a first layer. A mask may be applied to a lower surface of the thin glass layer. A clear adhesive is then positioned between the thin glass layer and a transparent plastic layer. At some positions the clear adhesive will come into contact with and one or more of a transparent sensor, flexible traces, and the transparent plastic layer. The transparent plastic layer can be configured such that it wraps around the end of the cover lens (not shown), or so that it extends to the peripheral two-dimensional geometry of the cover lens. A transparent adhesive can also be provided above the cover lens and below the transparent plastic. The sensor, such as would be formed from a transparent conductor, can be connected to, incorporated with, or in communication with flexible metal traces that wrap around the end of the cover lens where a flex having a chip can be connected to the wrap around leads of the cover glass or lens via an ACF. The flex can be transparent. Moreover, transparent conductors can combine with the flex. As with the prior configurations, the entire electronic device interface can be positioned within a housing of a suitable electronic device. The fingerprint sensor can be patterned in Cu or another non-transparent conductor and located under the ink mask while the transparent touch sensor can be made using the same layer, if desired, or additional layers. In at least some configurations, the touch sensor and the fingerprint sensor can be positioned on the same layer.

In some configurations, for example, copper traces can be used to form the flexible traces and the fingerprint sensor, while transparent conductors can be used to form the transparent sensor.

It will be understood by those skilled in the art that a method and system is disclosed which may comprise a biometric object sensor comprising: at least one conductive layer formed from one of a transparent or translucent material and formed in at least one of on or in or under an outer layer of a user device housing; at least one of a transmitter trace and at least one of a receiver trace formed from the at least one of the transparent or translucent material in the conductive layer. The transparent or translucent material may form at least a portion of a touch screen display on a user device. The at least one of a transmitter trace and at least one of a receiver trace may comprise one of a plurality of transmitter traces and a receiver trace formed on the sensing surface and a plurality of receiver traces and a transmitter trace formed in or on the touch screen display or one of a plurality of transmitter traces and formed in or on the touch screen display and a plurality of receiver traces formed in or on the touch screen display and separated from the transmitter traces by a dielectric material. The plurality of transmitter traces and receiver traces may be formed to define a plurality of transmitter/receiver crossover pixel positions.

The biometric sensor apparatus and method may comprise a fingerprint on a finger of a user. The biometric sensor and method may comprise the transparent or translucent material being selected from a group containing indium tin oxide, carbon nanotubes, metal nanowires, conductive transparent polymers and fine line metal.

The biometric sensor apparatus and method may comprise a sensor housing that may comprise a sensor substrate that may comprise at least one of a transmitter trace and a receiver trace formed on a sensing surface of the sensor substrate; the sensor housing contained within a user device may comprise a user device housing and an outer surface of the user device housing; and the sensor housing contained within the user device housing with at least the sensing surface of the sensor positioned within a biometric sensing distance of up to 250 μm from one of an outer surface of the user device housing and an opening in the user device housing. The at least one of a transmitter trace and at least one of a receiver trace may comprise one of a plurality of transmitter traces and a receiver trace formed on the sensing surface and a plurality of receiver traces and a transmitter trace formed on the sensing surface.

The at least one of a transmitter trace and a receiver trace may comprise a plurality of transmitter traces formed in the sensor substrate or on the sensor substrate and a plurality of receiver traces formed in the sensor substrate or on the sensor substrate and separated from the transmitter traces by a dielectric material. The plurality of transmitter traces and receiver traces may be formed to define a plurality of transmitter/receiver crossover pixel positions. The biometric may comprise a fingerprint on a finger of a user. The sensor substrate may comprise a flexible material. The biometric sensor and method may comprise at least one of a planarization layer, an optical coating, an optically clear adhesive, a clear plastic film, and a hard coat. The sensing surface of the sensor substrate may be covered by a layer protective layer selected from the group that may comprise an ultra-thin glass and polyethylene terephthalate.

A method of authenticating biometric information is disclosed which may comprise: utilizing a housed sensor contained within a housing of a user device and comprising at least one sensor trace positioned within 250 microns of an uppermost surface of the user device; sensing biometric information associated with a user using the at least one sensor; comparing the sensed biometric information with a stored biometric template associated with the user; and releasing at least one credential of the user if the biometric information matches the stored the biometric template. The method may comprise transmitting the credentials to a remote authentication requesting processor.

The device further may include sensor control logic configured to control the basic operations of the sensor element. The exact operations of the sensor element governed by the sensor logic control can depends on a particular sensor configuration employed, which may include power control, reset control of the pixels or data contact points, output signal control, cooling control in the case of some optical sensors, and other basic controls of a sensor element. Sensor controls are well known by those skilled in the art, and, again, depend on the particular operation.

Sensing device further can be adaptable to include a readout circuit for reading analog output signals from a sensor element(s) when it is subject to a fingerprint juxtaposed on a sensor surface. A readout circuit can further include an amplifier configured to amplify the analog signal so that it can more accurately be read in subsequent operations. A low pass filter can be configured to filter out any noise from the analog signal so that the analog signal can be more efficiently processed. The readout circuit can further include an analog-to-digital (A/D) converter that is configured to convert the output signal from a sensor elements) to a digital signal that indicates a series of logic 0's and 1's that define the sensing of the fingerprint features by the pixels or data contact points on a sensor surface. Such signals may be separately received, e.g., by motion sensors and the fingerprint sensing surfaces, and may be read out and processed separately.

The readout circuit may store the output signal in a storage, where fingerprint data is stored and preserved, either temporarily until a processor can process the signal, or for later use by the processor. The processor can include an arithmetic unit configured to process algorithms used for navigation of a cursor, and for reconstruction of fingerprints. Processing logic is configured to process information and can include analog to digital converters, amplifiers, signal filters, logic gates (all not shown) and other logic utilized by a processor. A persistent memory may be used to store algorithms and software applications that are used by the processor for the various functions described above, and in more detail below. A system bus may include a data bus configured to enable communication among the various components contained in the sensing device. As will be appreciated by those skilled in the art, that memory and storage can be any suitable computer readable media.

The system can further include a controller communicating with the fingerprint sensor transmitter and/or receiver element traces to capture a fingerprint image when a user's fingerprint is positioned on or swiped over the fingerprint sensor traces. In one system, there may be separate controllers for both the display and the fingerprint sensor, where the system is configured to include a display controller configured to control the visible display separate from the fingerprint sensor operations. Alternatively, a single controller may be used to control, for example, the visible display and the fingerprint sensor operations. The fingerprint sensor could also be patterned onto the top glass of the display itself, and not onto a touch-screen layer.

Sensors and form factors as described can be used within a communication network. As will be appreciated by those skilled in the art, the present disclosure may also involve a number of functions to be performed by a computer processor, such as a microprocessor, and within a communications network. The microprocessor may be a specialized or dedicated microprocessor that is configured to perform particular tasks according to the disclosure, by executing machine-readable software code that defines the particular tasks embodied by the disclosure. The microprocessor may also be configured to operate and communicate with other devices such as direct memory access modules, memory storage devices, Internet related hardware, and other devices that relate to the transmission of data in accordance with the disclosure. The software code may be configured using software formats such as Java, C++, XML (Extensible Mark-up Language) and other languages that may be used to define functions that relate to operations of devices required to carry out the functional operations related to the disclosure. The code may be written in different forms and styles, many of which are known to those skilled in the art. Different code formats, code configurations, styles and forms of software programs and other means of configuring code to define the operations of a microprocessor in accordance with the disclosure will not depart from the spirit and scope of the disclosure.

Within the different types of devices, such as laptop or desktop computers, hand held devices with processors or processing logic, and also possibly computer servers or other devices that utilize the disclosure, there exist different types of memory devices for storing and retrieving information while performing functions according to the disclosure. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the disclosure when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the disclosure as described herein enable the physical transformation of these memory devices. Accordingly, the disclosure as described herein is directed to novel and useful systems and methods that, in one or more embodiments, are able to transform the memory device into a different state. The disclosure is not limited to any particular type of memory device, or any commonly used protocol for storing and retrieving information to and from these memory devices, respectively.

A single medium or multiple media (e.g., a centralized or distributed database, and/or associated caches and servers) that store one or more sets of instructions can be used. Any medium, such as computer readable media, that is capable of storing, encoding or carrying a set of instructions for execution by a machine and that causes the machine to perform any one or more of the methodologies of the disclosure is suitable for use herein. The machine-readable medium, or computer readable media, also includes any mechanism that provides (i.e., stores and/or transmits) information in a form readable by a machine (e.g., a computer, PDA, cellular telephone, etc.). For example, a machine-readable medium includes memory (such as described above); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers or as different virtual machines. Moreover, the computer readable media can be positioned anywhere within the network.

Networked computing environment include, for example a server in communication with client computers via a communications network. The server may be interconnected via a communications network (which may be either of, or a combination of a fixed-wire or wireless LAN, WAN, intranet, extranet, peer-to-peer network, virtual private network, the Internet, or other communications network) with a number of client computing environments such as tablet personal computer, mobile telephone, smart phone, telephone, personal computer, and personal digital assistant. In a network environment in which the communications network is the Internet, for example, server can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment can utilize various data security protocols such as secured socket layer (SSL) or pretty good privacy (PGP). Each client computing environment can be equipped with operating system operable to support one or more computing applications, such as a web browser (not shown), or other graphical user interface (not shown), or a mobile desktop environment (not shown) to gain access to server computing environment.

As will be appreciated by those skilled in the art, any of the devices within the communication network that have a display (e.g., computer, smart phone, and PDA) can be configured to acquire data from a fingerprint sensor, as described above. Additionally information from the fingerprint sensors can then be transmitted to other devices within the network to facilitate authentication of a user within a network environment regardless of whether the receiving device had a display.

The devices disclosed herein can be used as part of a communication network to provide a mechanism for authenticating biometric information. For example, biometric information can be sensed that is associated with a user; the sensed information can then be compared with a biometric template associated with the user; if the biometric information matches the biometric template, credentials associated with the user can be received based on the biometric information. Additionally, credentials can be communicated, for example, to a requesting process. In another process, a biometric device installed in a client device with a web-enabled application can be identified. Thereafter biometric information associated with a user is identified whereupon a biometric template associated with the biometric information of the user is created. The system can be configured to receive user credentials associated with the user and to bind the user credentials with the biometric template. A web browser application can also be provided that is executable on the devices disclosed which includes a biometric extension configured to communication with the sensors disclosed via, for example, a biometric service and one or more web servers. Tokens can also be used to identify a valid user activation as part of the operation of the disclosed devices.

The use of integratable sensors facilitates the use of, for example, a web browser application that is configured on a client device and configured to be executed by a client processor on the device to facilitate conducting a secure transaction, such as a financial transaction, remotely which is authenticated based on information acquired by an integratable sensor such as those disclosed.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A biometric object sensor comprising:
at least one conductive layer formed from one of a transparent or translucent material and formed in at least one of on or in or under an outer layer of a user device housing;
at least one of a transmitter trace and at least one of a receiver trace formed from the at least one of the transparent or translucent material in the conductive layer.

2. The biometric sensor of claim 1 further comprising:
the transparent or translucent material forming at least a portion of a touch screen display on a user device.

3. The biometric sensor of claim 2 further comprising:
the at least one of a transmitter trace and at least one of a receiver trace comprising one of a plurality of transmitter traces and a receiver trace formed on the sensing surface and a plurality of receiver traces and a transmitter trace formed in or on the touch screen display.

4. The biometric sensor of claim 3 further comprising:
the at least one of a transmitter trace and at least one of a receiver trace comprising one of a plurality of transmitter traces and formed in or on the touch screen display and a plurality of receiver traces formed in or on the touch screen display and separated from the transmitter traces by a dielectric material.

5. The biometric sensor of claim 4 further comprising:
the plurality of transmitter traces and receiver traces formed to define a plurality of transmitter/receiver crossover pixel positions.

6. The biometric sensor of claim 5 further comprising:
the biometric comprising a fingerprint on a finger of a user.

7. The biometric sensor of claim 1 further comprising:
the transparent or translucent material selected from a group containing indium tin oxide, carbon nanotubes, metal nanowires, conductive transparent polymers and fine line metal.

8. The biometric sensor of claim 6 further comprising:
the transparent or translucent material selected from a group containing indium tin oxide, carbon nanotubes, metal nanowires, conductive transparent polymers and fine line metal.

9. A biometric sensor comprising:
a sensor housing comprising a sensor substrate comprising at least one of a transmitter trace and a receiver trace formed on a sensing surface of the sensor substrate;
the sensor housing contained within a user device comprising a user device housing and an outer surface of the user device housing;
the sensor housing contained within the user device housing with at least the sensing surface of the sensor positioned within a biometric sensing distance of up to 250 μm from one of an outer surface of the user device housing and an opening in the user device housing.

10. The biometric sensor of claim 9 further comprising:
the at least one of a transmitter trace and at least one of a receiver trace comprising one of a plurality of transmitter traces and a receiver trace formed on the sensing surface and a plurality of receiver traces and a transmitter trace formed on the sensing surface.

11. The biometric sensor of claim 9 further comprising:
the at least one of a transmitter trace and a receiver trace comprising a plurality of transmitter traces formed in the sensor substrate or on the sensor substrate and a plurality of receiver traces formed in the sensor substrate or on the sensor substrate and separated from the transmitter traces by a dielectric material.

12. The biometric sensor of claim 11 further comprising:
the plurality of transmitter traces and receiver traces formed to define a plurality of transmitter/receiver crossover pixel positions.

13. The biometric sensor of claim 12 further comprising:
the biometric comprising a fingerprint on a finger of a user.

14. The biometric sensor of claim 9 further comprising:
the sensor substrate comprising a flexible material.

15. The biometric sensor of claim 13 further comprising:
the sensor substrate comprising a flexible material.

16. The biometric sensor of claim 9 further comprising:
a planarization layer, an optical coating, an optically clear adhesive, a clear plastic film, and a hard coat.

17. The biometric sensor of claim 15 further comprising:
a planarization layer, an optical coating, an optically clear adhesive, a clear plastic film, and a hard coat.

18. The biometric sensor of claim 9 further comprising:
the sensing surface of the sensor substrate covered by a layer protective layer selected from the group comprising an ultra-thin glass and polyethylene terephthalate.

19. A method of authenticating biometric information comprising:
utilizing a housed sensor contained within a housing of a user device and comprising at least one sensor trace positioned within 250 microns of an uppermost surface of the user device;
sensing biometric information associated with a user using the at least one sensor;
comparing the sensed biometric information with a stored biometric template associated with the user; and
releasing at least one credential of the user if the biometric information matches the stored the biometric template.

20. The method of claim 19 further comprising:
transmitting the credentials to a remote authentication requesting processor.
